(19) United States
(12) Patent Application Publication
(10) Pub. No.: US 2006/0123182 A1
(43) Pub. Date: Jun. 8, 2006

(54) Distributed KVM and peripheral switch

(76) Inventors: Francisc Sandulescu, Bucuresti (RO); Adrian Bica, Solon, OH (US); Justin Thomas Gierke, Lakewood, OH (US)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 11/006,400

(22) Filed: Dec. 7, 2004

(51) Int. Cl. G06F 13/00

(52) U.S. Cl. 710/316

(57) ABSTRACT

The present invention relates to a system and method for switching keyboard and mouse devices and video displays, as well as USB peripheral devices, between USB hosts and video sources over extended distances. Provided is a distributed KVM and peripheral switch where a USB keyboard and mouse is emulated to the host interfaces of the KVM and peripheral switch and a USB host is emulated to keyboard and mouse interfaces of the KVM and peripheral switch. In addition, the keyboard, mouse, display and peripheral devices are separated from the hosts and video sources by a non-USB communications channel.

### FIELD OF THE INVENTION

The present invention relates to communication with keyboard, mouse and video devices and, more specifically, to a system and method for switching keyboard, video and mouse connections between hosts and extending the distance between hosts and keyboard, video and mouse connections.

### BACKGROUND OF THE INVENTION

A keyboard, video and mouse switch (KVM switch) allows a keyboard, video display monitor and mouse to be switched to any of a number of computers when typically one or more person interacts with the computers but only one computer at a time. Recently, keyboard and mouse devices, as well as other peripherals, have moved toward Universal Serial Bus (USB) technology.

USB is a peripheral bus standard developed by the PC and telecom industry, including Compaq, DBC, IBM, Intel, Microsoft, NEC and Northern Telecom. USB defines a bus and protocols for the connection of computer peripherals to computers (and computers to each other). “Universal Serial Bus Specification,” Compaq, Intel, Microsoft, NEC, Revision 1.1, Sep. 23, 1998, describes USB and its implementation and is incorporated herein by reference. In addition to standard USB devices and technologies, a newer USB standard 2.x now exists. “Universal Serial Bus Specification,” Compaq, Hewlett-Packard, Intel, Lucent, Microsoft, NEC, Philips, Revision 2.0, Apr. 27, 2000 describes the most current USB 2.x standard and its implementation and is incorporated herein by reference. The USB 2.x standard permits faster data transmission than the USB 1.x standard.

KVM switches are designed to connect keyboard and mouse devices to keyboard and mouse connection ports of computers. When switching keyboard and mouse devices between hosts, it may be desirable for it to appear to the host that the keyboard and mouse are always connected, even when they have been “switched” to another host. This is referred to as emulation. This “permanent connection” enables auto-boot functionality and translation.

As computer peripherals, and particularly USB peripherals, become increasingly more popular, the need to switch peripheral devices, as well as keyboard and mouse devices, becomes more pressing. Therefore, it may be desirable for a KVM switch to be capable of switching, either concurrently or independently, keyboard and mouse devices and peripheral devices.

Proposed and actual USB devices include keyboards, mice, telephones, digital cameras, modems, digital joysticks, CD-ROM drives, tape and floppy drives, digital scanners, printers, MPEG-2 video-base products, data digitizers, and other devices. USB protocol supports the dynamic insertion and removal of such devices from the bus (or “hot-plugging”) and recognizes actual peripherals or “functions”; hosts (typically a computer); and hubs, which are intermediate nodes in the network that allow the attachment of multiple upstream hubs or functions. Upon insertion of a downstream hub or function, the host/hub on the upstream side of the bus initiates a bus enumeration to identify and configure the new device. Upon removal, the removed device is “forgotten.”

Due to the stringent electrical signal requirements of USB standard specifications, it is difficult to meet the electrical specifications for USB signaling using simple amplifiers or special cable. Accordingly, a USB cable longer than approximately 5-10 meters generally will not work, even when using active terminations. In part, extending USB cables beyond approximately 5-10 meters is difficult because signal symmetry and skew can become compromised. It would be preferable if USB devices could be connected by a technology that permits the devices to be more than approximately 5-10 meters from a host.

One method of increasing the distance between a USB device and a host is to use signal translation to convert USB signals into an alternate signal capable of traveling more than 10 meters without distortion. Unfortunately, even if a USB signal is translated such that the electrical specifications are met, the USB timing specifications may limit the length of the extender to approximately 50-80 meters. According to USB 1.x standards, answers to messages originating from a host must be received within about 1333 nanoseconds (ns) or the host will generate an error. The 1333 ns includes the time required for the message to travel from the host to the peripheral device (referred to as the host to device trip time); the time required for the device to answer the host; and the time required for the message to travel from the device to host (referred to as the device to host trip time). Also according to USB 1.x standards, the trip time (host to device and/or device to host) is specified to be not longer than 380 ns.

Therefore, one can calculate the length of an extender to be 126 meters in an ideal case where there is no time required for the device to answer the host and where the cable transmits data at the speed of light. Typically, circuitry introduces delay of about 100 ns and the signal speed for common cables is about 1 meter per 5 ns, compared to the speed of light which is about 1 meter per 3 ns. Thus, for a “transparent” USB extender (referring to an extender that merely translates or converts signals from USB-type signals to another type of signal and back to USB-type signals) one can calculate a maximum limit of approximately 55 meters.

To extend USB signals beyond this calculated limit (approximately 55 meters), a different type of USB extender may be required. In order to prevent the generation of an error by the host due to response delay, a USB extender can be configured to immediately answer the host with a “not acknowledge” (NAK) response while sending the message to the device and awaiting the device's response. Upon receipt of the NAK response, the host will retry the original message about one millisecond later. When the host attempts to send the message again, the answer (from the device) may have been received by the extender and be immediately available for delivery to the host. While this type of USB extender allows for longer extensions, it decreases the available bandwidth, it is not transparent, and its implementation in both hardware and software is complex. Further, some USB devices and/or host drivers may not work with this type of extender.

Another method for extending USB signals beyond the calculated limit involves host and device emulation. In this configuration, the extender appears to the USB host as a USB device. Any requests from the USB host will be answered by the extender. The data and requests will then be sent via the extender to the USB device. The extender appears to the USB device as a USB host. Similarly, data sent from the USB device will be sent to the USB host via the extender and any necessary replies to the device will be generated by the extender.

As USB devices become increasingly more popular, the need to switch and extend USB devices becomes more pressing. Therefore, it may be preferable if a KVM switch were capable of switching USB keyboard and mouse devices and peripherals, either independently or concurrently, while extending the distance between the USB keyboard and mouse devices and a USB host.

### BRIEF SUMMARY OF THE INVENTION

According to an aspect of the present invention, there is provided a distributed KVM and peripheral switch comprising: a host unit communicably coupleable to a non-USB channel and a plurality of USB hosts; a device unit communicably coupleable to the non-USB channel and at least one keyboard and mouse, at least one USB peripheral and at least one video display; a master controller configured to switch the at least one keyboard and mouse among the USB hosts and configured to switch at least one of USB peripheral among the USB hosts.

According to another aspect of the present invention, there is provided a distributed KVM and peripheral switch comprising: a host unit communicably coupleable to a non-USB channel and at least one USB host and at least one video source; a device unit communicably coupleable to the non-USB channel and plurality of user input devices, at least one USB peripheral and a plurality of video displays; a master controller configured to switch the USB input devices among the USB hosts and configured to switch the at least one USB peripheral among the USB hosts.

Also according to the present invention, there is provided a method for switching keyboard and mouse data, USB peripheral data and video signals over an extended distance, the method comprising: receiving at a device unit USB keyboard and mouse data from a keyboard and mouse and USB peripheral data from a USB peripheral; converting the received USB keyboard and mouse data to non-USB keyboard and mouse data suitable for transmission over a non-USB communications channel; converting the received USB peripheral data to non-USB peripheral data suitable for transmission over a non-USB communications channel; receiving at a host unit video data from a video source; determining a destination USB host for the keyboard and mouse data, a destination USB host for the peripheral data and a destination video display for the video data; transmitting to a host unit the non-USB keyboard and mouse data and non-USB peripheral data via a non-USB communications channel; transmitting to a device unit the video data; converting the non-USB keyboard and mouse data received at the host unit to USB keyboard and mouse data; converting the non-USB peripheral data received at the host unit to USB peripheral data; transmitting the USB keyboard and mouse data and USB peripheral data to a USB host via a USB communications channel; and transmitting the video data to a video display via a video communications channel.

### BRIEF DESCRIPTION OF THE DRAWINGS

FIG. 1 is a block diagram of a system with a distributed KVM and peripheral switch;

FIG. 2 is a block diagram of the device unit of the distributed KVM and peripheral switch;

FIG. 3 is a block diagram of the host unit of the distributed KVM and peripheral switch;

FIG. 4 is a flow chart generally illustrating the data flow when switching keyboard, mouse and peripheral devices as well as video signals over an extended distance; and

FIG. 5 is a flow chart generally illustrating the switching command analysis when switching keyboard, mouse and peripheral devices as well as video signals over an extended distance.

### DETAILED DESCRIPTION OF THE INVENTION

The present invention relates to a system and method for switching and extending keyboard and mouse devices and USB peripherals between USB hosts.

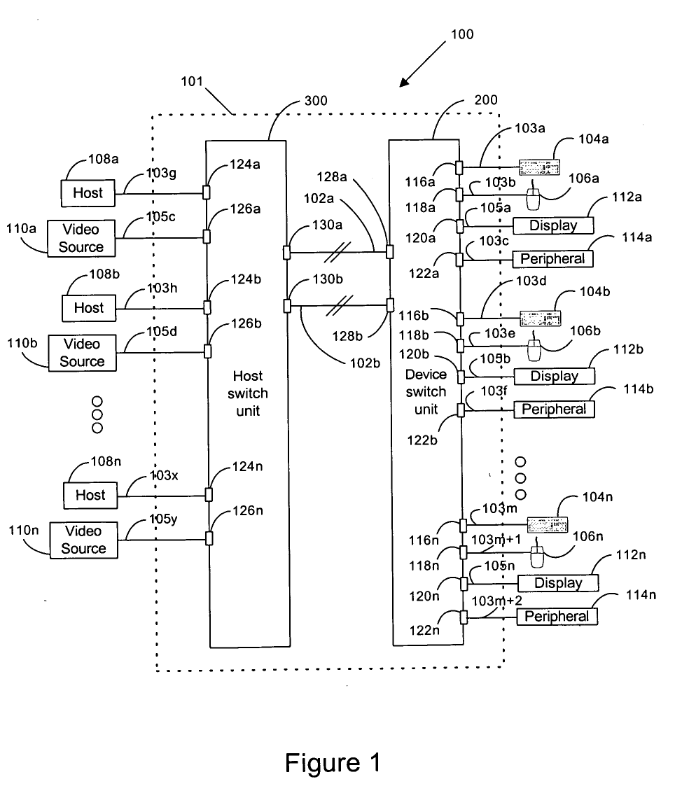

Turning initially to FIG. 1, a block diagram of a system with a distributed USB KVM and peripheral switch is illustrated. The distributed USB KVM and peripheral switch 100 is generally positioned between and connectable to at least one USB host 108x and video source 110x and at a display 112x and least one set of USB user input devices, each set including a keyboard 104x and mouse 106x, and at least one USB peripheral 114x. The switch 100 generally includes a device unit 200, a host unit 300 and at least one non-USB communications channel 102x. The switch 100 may be compatible with USB 1.x, USB 2.x or both. The hosts 108x may be any USB hosts. The keyboard 104x and mouse 106x may be any type of keyboard and mouse devices, such as PS/2, SUN, Macintosh, etc., but are preferably USB keyboard and mouse devices. The USB peripherals 114x may be any USB peripheral.

The device unit 200 is connectable to the host unit 300 via a non-USB communications channel 102x. Preferably, the device unit 200 is configured to receive USB data from at least one set of keyboard 104x and mouse 106x devices via a keyboard interface 116x and mouse interface 118x and USB communications channels 103x, convert the received data to non-USB data suitable for transmission over a non-USB communications channel 102x, determine which USB host 108x is to receive the converted data and transmit the converted data to the host unit 300 via a non-USB communications channel 102x. The device unit 200 is also preferably configured to receive USB data from at least one peripheral 114x via a peripheral interface 122x and USB communications channel 103x, convert the received data to non-USB data suitable for transmission over a non-USB communications channel 102x, determine which USB host 108x is to receive the converted data and transmit the converted data to the host unit 300 via a non-USB communications channel 102x.

The device unit 200 may also be configured to receive non-USB data from the host unit 300 via a non-USB communications channel 102x, convert the received data to USB data and transmit the USB data to a keyboard 104x and mouse 106x via the keyboard and mouse interfaces 116x and 118x and at least one USB communications channel 103x. Likewise, the device unit 200 may also be configured to receive non-USB data from the host unit 300 via a non-USB communications channel 102x, convert the received data to USB data and transmit the USB data to a peripheral 114x via a peripheral interface 122x and a USB communications channel 103x.

The device unit 200 is also connectable to a video display 112x via a video communications channel 105x. The device unit 200 is configured to receive video data from the host unit 300 via a non-USB communications channel 102x and transmit video data to a video display 112x via a video interface 120x and video communications channel 105x. The device unit may also be configured to receive video device data from the video display 112x via the video interface 120x and prepare and transmit to the host unit 300 the received video device data over a non-USB communications channel 102x. The video device data may be combined, such as by multiplexing, and transmitted with the data received from a keyboard 104x and mouse 106x.

The host unit 300 is connectable to at least one host 108x via a USB cable 103x and is configured to convert the non-USB data received via the non-USB communications channel 102x to USB data for transmission to the desired host 108x based on information received from the device unit 200. The host unit 300 is configured to transmit to the host 108x the converted USB data via the USB host interface 124x and a USB communications channel 103x. The host unit 300 may also be configured to receive USB data from the host 108x via the USB communications channel 103x and USB host interface 124x, convert the received USB data to non-USB data suitable for transmission over a non-USB communications channel 102x, and transmit the converted non-USB data to the device unit 200 via a non-USB communications channel 102x.

The host unit 300 is also connectable to a video source 110x via a video communications channel 105x and video source interface 126x. The host unit 300 is configured to receive video data from the video source 110x via the video communications channel 105x and prepare and transmit to the device unit 200 the received video data over the non-USB communications channel 102x. The host unit may also be configured to receive video device data from the device unit 200 via the non-USB communications channel 102x and prepare and transmit the received video device data to the video source 110x.

The non-USB communications channel 102x may be any type of non-USB communications channel, such as a wire-based category 5 (CAT5) communications channel or wireless communications channel. Such communication channels include, for example, Ethernet, Token-Ring™, fiber optic, 802.11-type wireless data transmission, or other wire-based or wireless data communication mechanisms as will be apparent to one of ordinary skill in the art.

In one exemplary embodiment, the non-USB communications channel 102x is an at least four pair communications channel. Three of the pairs may be used to transmit video data and one of the pairs may be used to transmit USB data. In addition, video device data may be combined, such as by multiplexing, e.g., time multiplexing, with the USB data and transmitted via the one pair. For non-USB communications channels 102x having more than four pairs, video device data may also be transmitted via an additional pair. The video device data may be Display Data Channel (DDC) data, or the like. DDC is a standard created by the Video Electronics Standard Association (VESA) that facilitates control through software of the settings of a graphical terminal, such as a monitor. For the purpose of the present invention, the video data can be switched using any video switch. Accordingly, only the keyboard, mouse and peripheral switching capabilities are detailed herein. It will be understood that the distributed KVM and peripheral switch 100 includes a video switch communicably coupled to the video data path configured to switch the video displays 112x between the host video sources 110x. The video data can be switched either concurrently or independently with the keyboard and mouse through the use of technology known in the art. Any video switching technology known in the art may be used.

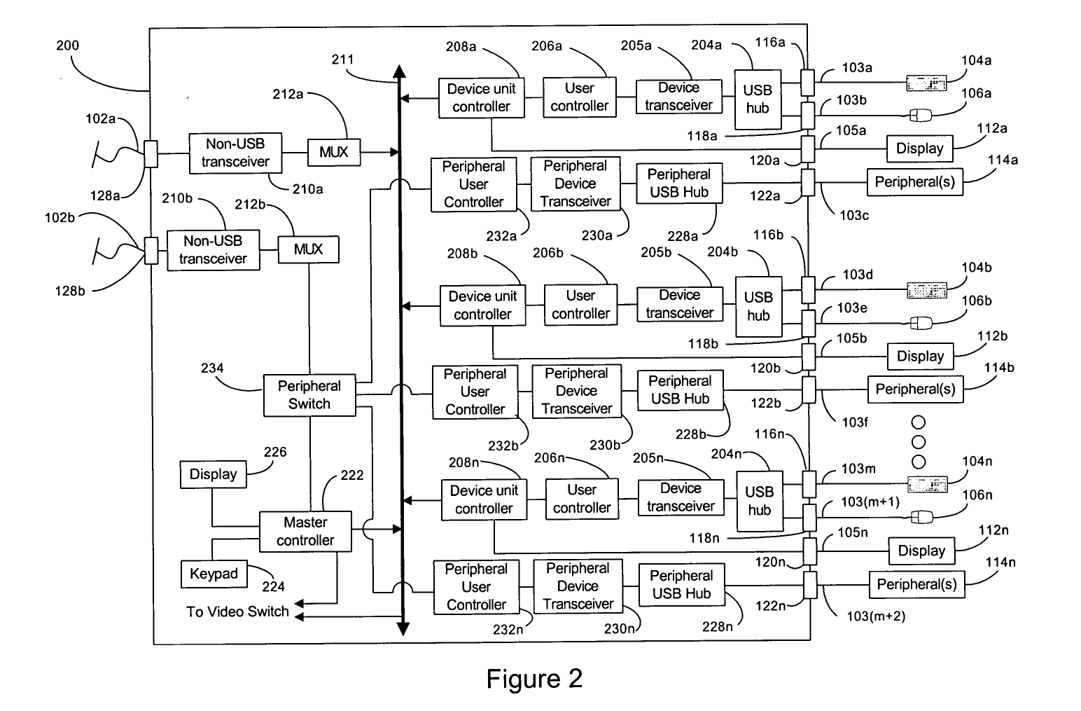

Turning next to FIG. 2, a block diagram of the device unit of the KVM and peripheral switch is illustrated. Referring first to the keyboard and mouse data path, each keyboard 104x and mouse 106x is connected to the device unit 200 via a keyboard interface 116x and mouse interface 118x, respectively. In the presently preferred embodiment, the keyboard 104x and mouse 106x are USB devices. Thus, a USB hub 204x is utilized. It will be understood by those skilled in the art, however, that other types of keyboard and mouse devices may be utilized. For example, the keyboard interface 116x and mouse interface 118x may be a universal interface configured to accept different types of keyboard and mouse devices. Such universal interface is described in U.S. Pat. No. 6,324,605 which is incorporated herein by reference.

When using USB keyboard and mouse devices, each keyboard interface 116x and mouse interface 118x may be communicably coupled to a corresponding USB hub 204x. The USB hub 204x is configured to enable full speed signaling of messages through the switch 100, even if all the devices connected to the switch 100 are low speed.

The USB hub 204x is connected to a USB device transceiver 205x. The USB device transceiver 205x may be a circuit implementing the physical layer for the transmission protocol, such as a USB 2.0 PHY or the like. The USB device transceiver 205x may be a “host type” transceiver in that, to the keyboard 104x and mouse 106x, the USB device transceiver 205x appears to be a USB host 108x. The USB device transceiver 205x is configured to receive USB data from the USB hub 204x, convert the received USB data to non-USB data, such as I²C, and transmit the converted non-USB data to a user controller 206x. The USB device transceiver 205x may also be configured to receive non-USB data from the user controller 206x, convert the received non-USB data to USB data, and transmit the converted data to the keyboard 104x and mouse 106x via the USB hub 204x, the keyboard interface 116x and the mouse interface 118x, and the USB cable(s) 103x.

The USB device transceiver 205x is communicably coupled to a user controller 206x, which is in turn communicably coupled to a device unit controller 208x, which is in turn communicably coupled to a BUS 211. The user controller 206x may be any standard USB device controller known in the art. The user controller 206x may be configured to emulate a USB host (e.g., a USB host 108x) so that from the view of the user input devices 104x and 106x, the keyboard 104x and mouse 106x are in direct communication with a USB host 108x. The user controller 206x is configured to receive the converted data from the device transceiver 205x and transmit the data to a device unit controller 208x.

The device unit controller 208x is configured to determine the nature of the data received from the user controller 206x and transmit the data to a multiplexer/demultiplexer (MUX) 212a via the BUS 211. The device unit controller 208x may also be configured to determine if each non-USB command received from the BUS 211 is intended for the specific devices 104x and 106x attached along the same direct data path, and if so, transmit the data to the user controller 206x.

When the device unit controller 208x transmits data to either the BUS 211 or the user controller 206x, the device unit controller 208x may perform signal amplifying and/or reshaping on either or both of the USB data and the video device data to compensate for the increased transmission path due to the distributed KVM and peripheral switch 100. Further, the device unit controller 208x may also determine the direction of each command or message so that the data transmitted from the device unit controller 208x is transmitted in the correct direction.

A BUS 211 is communicably coupled to the device unit controller 208x. The BUS 211 may be any communication bus, such as an I²C bus or the like. A master controller 222 is also communicably coupled to the BUS 211. Thus, the master controller 222 is communicably coupled to the device unit controller 208x and the MUX 212a via the BUS 211. Furthermore, the master controller 222 may be communicably coupled to a video switch, a peripheral switch 234 and to at least one user interface, such as the user interfaces labeled as the keypad 224 and the display 226.

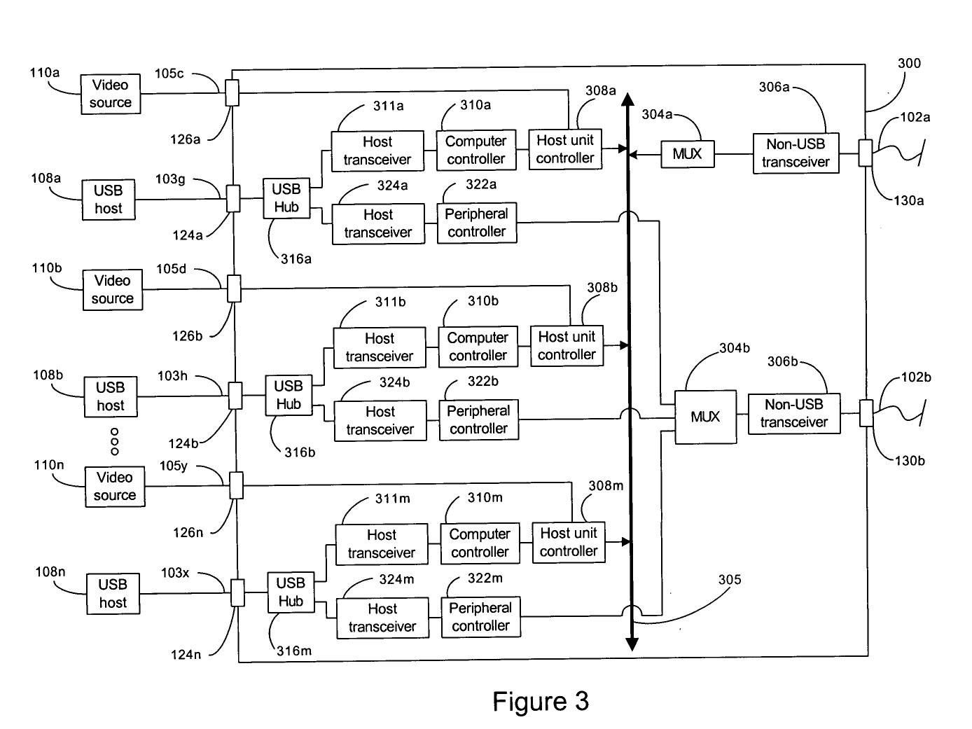

Turning now to both FIG. 2 and FIG. 3, the master controller 222 controls switching. The master controller 222 is configured to interpret switching commands received from a user interface, such as the keypad 224. The master controller 222 may be configured to direct the device unit controller 208x to communicate the converted USB data to a host unit controller 308x, via the BUS 211, the MUX 212a, a non-USB transceiver 210a, the device interface 128a, the non-USB communications channel 102a, the host interface 130a, a non-USB transceiver 306a, a MUX 304a, and a BUS 305. In addition, the master controller 222 may also be configured to direct the host unit controller 308x to communicate commands to a device unit controller 208x via the BUS 305, the MUX 304a, the non-USB transceiver 306a, the host interface 130a, the non-USB communications channel 102a, the device interface 128a, the non-USB transceiver 210a, the MUX 212a, and the BUS 211.

The switching commands received from the user interface may contain identification information. Such identification information may include, for example, a user identification number corresponding to the user requesting the switch and a computer identification number corresponding to the computer to which the user wishes to connect.

The user identification information may inform the master controller 222 which device unit controller 208x will communicate with which host unit controller 308x. Thus, based on the computer information and/or user information, the master controller 222 may instruct, for example, the device unit controller 208b to communicate with the host unit controller 308a, which supervises the operation of the USB host 108a and video source 110a.

It will be understood by those skilled in the art that it is possible to have multiple device unit controllers 208x in communication with the same host unit controller 308x. In such configurations, the host unit controller 308x may implement a “priority receive” and communicate with the first device unit controller 208x to begin communications-all others will be ignored until a time-out period has passed in which there have been no communications from any of the device unit controllers 208x.

The master controller 222 may also be configured to implement security features. The master controller 222 may allow and disallow certain device unit controller 208x and host unit controller 308x connections based on permissions. If the master controller 222 receives a request for a connection that is not allowed, the master controller 222 may deny the connection request and respond back to the display 226 that the connection cannot be made. Further, connections also may be password and/or biometric data protected. Upon receiving a request for a connection that is password protected, the master controller 222 may require an appropriate password. Once the correct password has been received and authenticated, the master controller 222 may transmit the commands to the appropriate device unit controller 208x and host unit controller 308x. If authentication fails, the master controller 222 may deny the request or offer another chance for a user to re-enter the correct password.

Also coupled to the BUS 211 is a MUX 212a. The MUX 212a performs multiplexing/demultiplexing functions and may use any multiplexing/demultiplexing technology known in the art. The MUX 212a functions to combine data signals located on the BUS 211 from the device unit controllers 208x and the master controller 222 in order to send the information to the host unit 300 over the non-USB communications channel 102a. The MUX 212a may also receive data sent by the host unit 300 via the non-USB communications channel 102a and separate the information into the different data signals that were combined by the MUX 304a in the host unit 300. In an exemplary embodiment, the USB data is sent over a single pair of the non-USB communications channel 102a.

Depending on the type of video extension used, the MUX 212a may also function to separate video data signals from one another and/or from data signals. The various ways to separate and combine multiple sources of data for transmission are known to one having ordinary skill in the art.

The non-USB transceiver 210a is configured to receive non-USB data from the host unit 300 via the non-USB communications channel 102a and the device interface 130a and transmit the non-USB data to the MUX 212a. The non-USB transceiver 210a may also be configured to receive non-USB data from the MUX 212a and transmit the received data to the host unit 300. Because the shape of the incoming signal from the host unit 300 can be distorted by the extended travel path, the non-USB transceiver 210a may also function to correct signal distortion and degradation. In addition, the non-USB transceiver 210a may also perform signal amplifying functions in order to compensate for the extended data path along the non-USB communications channel 102a.

Each of the device transceivers 205x, user controllers 206x, the device unit controllers 208x, the master controller 222, and the MUX 212a or 212b may be a control circuit implemented as one or combinations of the following: programmable circuit, integrated circuit, memory and I/O circuits, an application specific integrated circuit, microcontroller, complex programmable logic device, field programmable gate arrays, other programmable circuits, or the like. In addition, the device transceiver 205x, user controller 206x and device unit controller 208x may be implemented as a single controller.

Turning next to FIG. 3, once the information from the device unit controllers 208x and the master controller 222 is combined by the MUX 212a, the data is sent through the non-USB communications channel 102a to a non-USB transceiver 306a in the host unit 300. The non-USB transceiver 306a is configured to receive non-USB data from the device unit 200 via the non-USB communications channel 102a and the host interface 130 and transmit the non-USB data to the MUX 304a. The non-USB transceiver 306a may also be configured to receive non-USB data from the MUX 304a and transmit the received data to the device unit 200 via the non-USB communications channel 102a. Because the shape of the incoming signal from the device unit 200 can be distorted by the extended travel path, the non-USB transceiver 306a may also function to correct signal distortion and degradation. In addition, the non-USB transceiver 306a may also perform signal amplifying functions in order to compensate for the extended data path along the non-USB communications channel 102a.

A MUX 304a is communicably coupled to the non-USB transceiver 306a. The MUX 304a performs multiplexing/demultiplexing functions and may use any multiplexing/demultiplexing technology known in the art. The MUX 304a receives data from the non-USB transceiver and separates the information into the different data signals that were combined by the MUX 212a in the device unit 200. The MUX 304a may also function to combine data signals located on the BUS 305 from the host unit controllers 308x in order to send information from the data signals to the device unit 200 over the non-USB communications channel 102a.

A host unit controller 308x is communicably coupled to the MUX 304a via the BUS 305. The host unit controller 308x may be configured to determine the nature of the non-USB data received from the computer controller 310x and to transmit the data to the non-USB transceiver 306a via the MUX 304a. The host unit controller 308x may also be configured to receive data from the MUX 304a via the BUS 311 and transmit the received data to the computer controller 310x. Further, the host unit controller 308x may also determine the direction of each command or message so that the data transmitted from the host unit controller 308x is transmitted in the correct direction.

The host unit controller 308x may function to decode or calculate data received from the master controller 222 and placed on the BUS 305. This decoding may determine which messages/data from the device unit controllers 208x are intended to be received by a particular USB host 108x. The data from the master controller 222 may be a separate stream of data from the information from the device unit controllers 208x or an integrated part of the data from each device unit controller 208x. The information from the master controller 222 may instruct certain USB devices 104x and 106x to exchange data with certain USB hosts 108x, and may also determine which video source 110x should be linked to which display 112x. In addition, the master controller may also determine which USB host 108x will exchange data with which USB peripheral 114x. The host unit controller 308x may also prevent, if the USB host 108x is silent, the transmission of video data from the video source 110x.

A computer controller 310x is communicably coupled to the host unit controller 308x. The computer controller 310x may be configured to emulate a USB device (e.g., the remote devices 104x and 106x) so that to the USB host 108x, the USB host 108x appears to be in direct communication with a USB device. The computer controller 310x is configured to receive non-USB data from the host transceiver 311x and send the data to the host unit controller 308x. The computer controller 310x may also be configured to receive non-USB data and to transmit the data to the host transceiver 311x. The computer controller 310x may also prevent, if the USB host 108x is silent, the transmission of video data from the video source 110x.

The USB host transceiver 311x is communicably coupled to the computer controller 310x and may be a circuit implementing the physical layer for the transmission protocol, such as a USB 2.0 PHY or the like. The USB host transceiver 311x may be a “device type” transceiver in that, to the USB host 108x, the USB host transceiver 311x appears to be a keyboard 104x and the mouse 106x. The USB host transceiver 311x is configured to receive non-USB data from the computer controller 310x, convert the non-USB data to USB data and transmit the USB data to a USB host 108x via a USB hub 316x, a USB host interface 124x and a USB cable 103x. The USB host transceiver 311x may also be configured to receive USB data from a USB host 108x, convert the USB data to non-USB data, and to transmit the non-USB data to a computer controller 310x.

Each of the computer controller 310x, the host unit controller 308x, the MUX 304a and the non-USB transceiver 306a may be a programmable circuit, memory and I/O circuits, an application specific integrated circuit, microcontroller, complex programmable logic device, field programmable gate arrays, other programmable circuits, or the like. In addition, the computer controller 310x, the host unit controller 308x, and the host transceiver 311x may be implemented as a single controller.

Referring next to the peripheral data path, FIGS. 2 and 3, peripherals 114x are connected to the device unit 200 via peripheral interfaces 122x. In the presently preferred embodiment, the peripherals 114x are USB devices. Thus, a USB hub, such as peripheral USB hub 228x, is utilized. The peripherals 114x are thus connected to peripheral USB hubs 228x via peripheral interfaces 122x. The peripheral USB hubs 228x are preferably configured to enable full speed signaling of messages through the switch 100, even if all the devices connected to the switch 100 are low speed.

The peripheral USB hub 228x is connected to a peripheral device transceiver 230x. The peripheral device transceiver 230x may be a circuit implementing the physical layer for the transmission protocol, such as a USB 2.0 PHY or the like. The peripheral device transceiver 230x may be a “host type” transceiver in that, to the peripheral 114x, the peripheral device transceiver 230x appears to be a USB host 108x. The peripheral device transceiver 230x is configured to receive USB data from the peripheral USB hub 228x, convert the received USB data to non-USB data, such as I²C, and transmit the converted non-USB data to a peripheral user controller 232x. The peripheral device transceiver 230x may also be configured to receive non-USB data from the peripheral user controller 232x, convert the received non-USB data to USB data, and transmit the converted data to a peripheral 114x via the peripheral USB hub 228x, a peripheral interface 122x and a USB cable 103x.

The peripheral device transceiver 230x is communicably coupled to a peripheral user controller 232x, which is in turn communicably coupled to a peripheral switch 234. The peripheral user controller 232x may be any standard device controller known in the art. The peripheral user controller 232x may be configured to emulate a USB host (e.g., the USB host 108x) so that from the view of the peripherals 114x, the peripherals 114x are in direct communication with a USB host 108x. The peripheral user controller 232x is configured to receive the converted data from the peripheral device transceiver 230x and transmit the data to a peripheral switch 234.

The peripheral user controller 232x may also be configured to determine if each command received from the peripheral switch 234 is intended for the specific USB devices 114x. Also, the peripheral user controller 232x may perform signal amplifying and/or reshaping on USB data to compensate for the increased transmission path between the USB host 108x and the USB peripheral 114x. Further, the peripheral user controller 232x may also determine the direction of each command or message so that the data commands transmitted from the peripheral user controller 232x are transmitted in the correct direction.

The master controller 222 preferably controls switching. It will also be understood by those skilled in the art that a separate peripheral master controller may be used to control peripheral switching. The master controller 222 is configured to interpret switching commands received from a user interface, such as the keypad 224. The master controller 222 may be configured to direct the peripheral user controller 232x to communicate the data to a peripheral controller 322x, via the peripheral switch 234, the MUX 212b, the non-USB transceiver 210b, the device interface 128b, the non-USB communications channel 102b, the host interface 130b, a non-USB transceiver 306b, and a MUX 304b. In addition, the master controller 222 may also be configured to direct the peripheral controller 322x to communicate commands to a peripheral user controller 232x via the MUX 304b, the non-USB transceiver 306b, the host interface 130b, the non-USB communications channel 102b, the device interface 128b, the non-USB transceiver 210b, the MUX 212b and the peripheral switch 234.

The peripherals 114x may be switched concurrently with the keyboard and mouse devices 104x and 106x or independently of the keyboard and mouse devices 104x and 106x and may be accomplished as described above with reference to switching keyboard and mouse devices 104x and 106x. Similarly, multiple peripherals 114x may be in communication with the same peripheral controller 322x. In such instances, a “priority receive” may be implemented.

Coupled to the peripheral switch 234 is a MUX 212b, which performs multiplexing/demultiplexing functions and may use any multiplexing/demultiplexing technology known in the art. The MUX 212b functions to combine data signals from the peripheral user controllers 232x and the master controller 222 in order to send the information to the host unit 300 over the non-USB communications channel 102b. The MUX 212b may also receive data sent by the host unit 300 via the non-USB communications channel 102b and separate the information into the different data signals that were combined by the MUX 304b in the host unit 300. In an exemplary embodiment, the USB data is sent over a single pair of the non-USB communications channel 102b.

The non-USB transceiver 210b is configured to receive non-USB data from the MUX 212b and transmit the received data to the host unit 300. The non-USB transceiver 210b may also be configured to receive non-USB data from the host unit 300 via the non-USB communications channel 102b and the device interface 128b and transmit the non-USB data to the MUX 212b. Because the shape of the incoming signal from the host unit 300 can be distorted by the extended travel path, the non-USB transceiver 210b may also function to correct signal distortion and degradation. In addition, the non-USB transceiver 210b may also perform signal amplifying functions in order to compensate for the extended data path along the non-USB communications channel 102b.

Each of the peripheral device transceivers 230x, peripheral user controllers 232x, the master controller 222 and the MUX 212b may be a control circuit implemented as one or combinations of the following: programmable circuit, integrated circuit, memory and I/O circuits, an application specific integrated circuit, microcontroller, complex programmable logic device, field programmable gate arrays, other programmable circuits, or the like. In addition, the peripheral device transceivers 230x and the peripheral user controllers 232x may be implemented as a single controller.

Turning next to FIG. 3, the data from the device unit 200 is sent via the non-USB communications channel 102b to the host unit 300. At the host unit 300, the data is received via the host interface 130b and non-USB transceiver 306b. The non-USB transceiver may be configured to transmit the received non-USB data to the MUX 304b. The non-USB transceiver 306b may also be configured to receive non-USB data from the MUX 304b and transmit the received data to the device unit 200 via the non-USB communications channel 102b. Because the shape of the incoming signal from the device unit 200 can be distorted by the extended travel path, the non-USB transceiver 306b may also function to correct signal distortion and degradation. In addition, the non-USB transceiver 306b may also perform signal amplifying functions in order to compensate for the extended data path along the non-USB communications channel 102b.

A MUX 304b is communicably coupled to the non-USB transceiver 306b. The MUX 304b performs multiplexing/demultiplexing functions and may use any multiplexing/demultiplexing technology known in the art. The MUX 304b receives data from the non-USB transceiver 306b and separates the information into the different data signals that were combined by the MUX 212b in the device unit 200. The MUX 304b may also function to combine data signals received from the peripheral controllers 322x in order to send information from the data signals to the device unit 200 over the non-USB communications channel 102b.

The data signals received from the device unit 200 are sent to a peripheral controller 322x. The peripheral controller 322x may function to decode or calculate data received from the master controller 222. This decoding may determine which messages/data from the peripheral user controllers 232x are intended to be received by a particular USB host 108x. The data from the master controller 222 may be a separate stream of data from the information from the peripheral user controllers 232x or an integrated part of the data from each peripheral user controller 232x. The information from the peripheral user controller 232x and peripheral controller 322x may instruct certain peripherals 114x to exchange data with certain USB hosts 108x.

Accordingly, the peripheral controller 232x is configured to send the received non-USB data to a host transceiver 324x. The peripheral controller 322x may also be configured to determine the nature of the non-USB data received from the host transceiver 324x and transmit the data to the non-USB transceiver 306b via the MUX 304b. Further, the peripheral controller 322x may also determine the direction of each command or message so that data is transmitted in the correct direction.

A host transceiver 324x is communicably coupled to the peripheral controller 322x and may be a circuit implementing the physical layer for the transmission protocol, such as a USB 2.0 PHY or the like. The host transceiver 324x may be a “device type” transceiver in that, to the USB host 108x, the host transceiver 324x appears to be a USB peripheral, such as peripheral 114x. The host transceiver 324x is configured to receive non-USB data from the peripheral controller 322x, convert the non-USB data to USB data, and to transmit the USB data to a USB host 108x via a USB hub 316x, a USB host interface 124x and a USB cable 103x. The host transceiver 324x may also be configured to receive USB data from a USB host 108x, convert the USB data to non-USB data, and to transmit the non-USB data to a peripheral controller 322x.

Each of the peripheral controller 322x, the MUX 304a and host transceiver 324x may be a programmable circuit, memory and I/O circuits, an application specific integrated circuit, microcontroller, complex programmable logic device, field programmable gate arrays, other programmable circuits, or the like. In addition, the peripheral controller 322x and the host transceiver 324x may be implemented as a single controller.

Turning now to the video device data path, beginning with FIG. 2, the device unit 200 is connected to a display 112x via a video communications channel 105x. More specifically, the display 112x may be communicably coupled to the device unit controller 208x via the display interface 120x and the video communications channel 105x. The device unit controller 208x may therefore be further configured to receive video device data from the display 112x and control the flow of the received video device data. The device unit controller 208x may be configured to convert the received video device data into another data format, such as I²C and place the converted data on the BUS 211.

Using video device data, such as DDC, a display, such as the display 112x, can communicate with a video source, such as the video source 110x. In other words, a graphical adapter can receive from the monitor all the information about its features and consequently, a graphical adapter is capable of automatic configuration for optimized refresh values depending on the resolution used.

To control video switching, the master controller 222 is communicably coupled to a video switch (not shown), which is in turn communicably coupled to the BUS 211. The video switch functions to switch the video data between video interfaces. Accordingly, the video switch is communicably coupled to at least one of the video interfaces 120x and is configured to switch the video interfaces 120x between host video interfaces 126x.

The MUX 212a may function to combine video device data received from the device unit controller 208x with the USB data received from the mouse 106x and keyboard 104x. The combination of data may be determined by information received from the master controller 222. In addition, this combination may be multi-layered in that video device data from display 112a, for example, may be combined with USB data from the keyboard 104a and mouse 106a. This combined data may also be combined with other combined data from, for example, keyboard 104b, mouse 106b, and display 112b. The order of combination may also be reversed. In an exemplary embodiment, the data is combined by time multiplexing the data.

The host unit 300 is configured to receive video device data combined with converted USB data from the device unit 200 via the non-USB communications channel 102a. The information sent by the MUX 212a in the device unit 200 is received by the MUX 304a in the host unit 300 via the non-USB communications channel 102a and the non-USB transceivers 210a and 306a. The MUX 304a may function to separate the signals combined by the MUX 212a, which may include converted USB data and video device data from multiple sources.

Once the video device data is separated, the MUX 304a sends the video device data to the host unit controller 308x via the BUS 305. The host unit controller 308x to which the video device data is sent may be determined from information from the master controller 222, in the same manner that the destination host unit controller 308x for the USB data is determined.

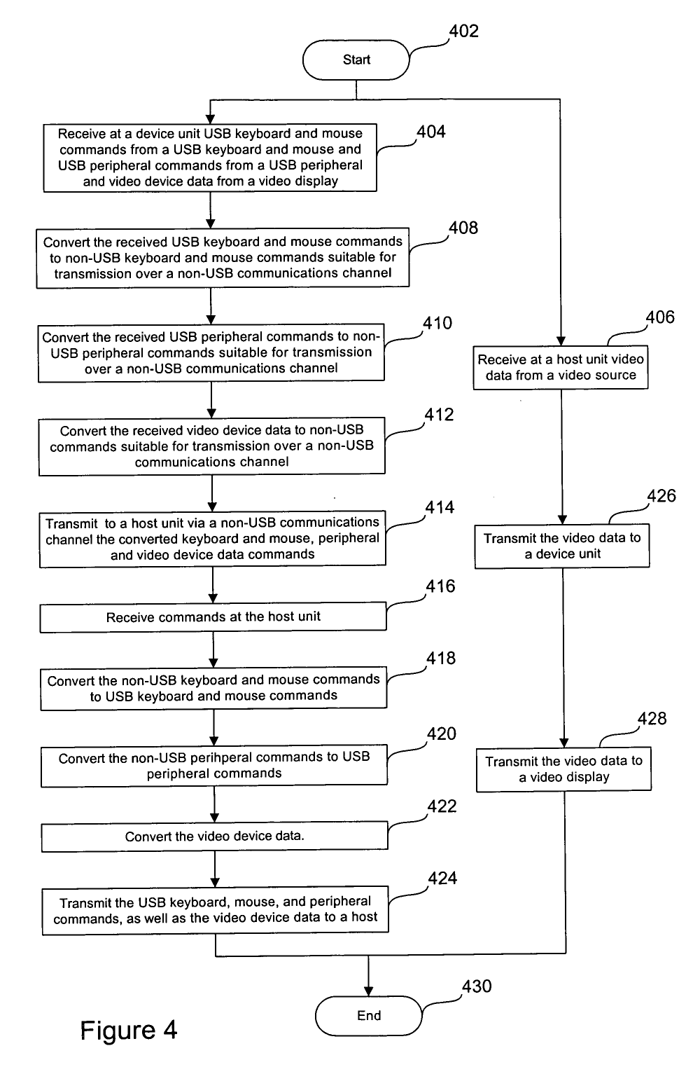

Turning next to FIG. 4, a flow chart generally illustrating part of the data flow when switching, over an extended distance, keyboard and mouse devices, video displays and peripheral devices is provided. The basic flow commences at start block 402, from which progress is made to process block 404.

At process block 404, USB keyboard and mouse data, video device data from a video display and USB peripheral data from a peripheral are received at a device unit, such as the device unit 200. Flow then continues to process block 408 wherein the USB keyboard and mouse data received at the device unit are converted to non-USB data suitable for transmission over a non-USB communications channel. Flow then progresses to process block 410 wherein the USB peripheral data received at the device unit is converted to non-USB data suitable for transmission over a non-USB communications channel. Flow then continues to process block 412 wherein the video device data received at the device unit is converted to non-USB data suitable for transmission over a non-USB communications channel.

Progression then continues to process block 414 wherein the converted keyboard and mouse commands, peripheral commands and video device data are transmitted over a non-USB communications channel to a host unit. Flow then continues to process block 416 wherein the converted commands are received at the host unit.

Flow then progresses to process block 418 wherein the received keyboard and mouse commands are converted to USB keyboard and mouse commands. Progression then continues to process block 420 wherein the received peripheral commands are converted to USB peripheral commands. Flow then continues to process block 422 wherein the received video device data is converted to data suitable for receipt by a video host.

Progression then continues to process block 424 wherein the USB keyboard and mouse commands, the USB peripheral commands, and the video device data are transmitted to a host, after which flow progresses to termination block 430.

Flow also progresses from start block 402 to process block 406 wherein video data from a video source is received at a host unit. Flow then continues to process block 426 wherein the video data is transmitted to a device unit. The video data may be transmitted over a non-USB communications channel. Flow then continues to process block 428 wherein the video data received at the device unit is transmitted to a video display. Progression then continues to termination block 430.

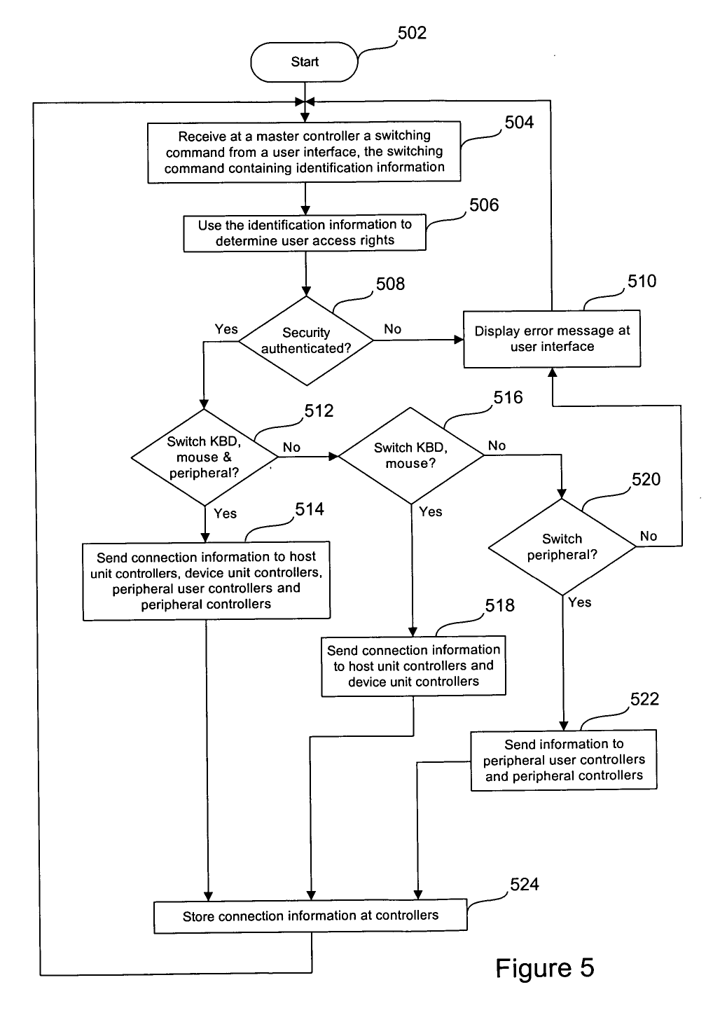

Turning next to FIG. 5, a flow chart illustrating the analysis of switching commands when switching keyboard, mouse and peripheral devices as well as video signals over an extended distance is provided. Flow begins at start block 502, from which progression is made to process block 504. At process block 504, a switching command from a user interface is received at a master controller. The switching command preferably contains identification information.

Flow then continues to process block 506 wherein the identification information contained in the switching command is used to determine user access rights. Progression then continues to decision block 508 wherein a determination is made whether identification information has been authenticated. A negative determination at decision block 508 causes progression to process block 510 wherein an error message is displayed to the user at a user interface. Progression then loops back to process block 504.

A positive determination at decision block 508 causes progression to decision block 512 wherein a determination is made whether to switch a keyboard, mouse and peripheral. A positive determination at decision block 512 causes progression to process block 514 wherein connection information is sent to host unit controllers, device unit controllers, peripheral user controllers and peripheral controllers. Flow then continues to process block 524 wherein the received connection information is stored by the controllers. Flow then loops back to process block 504.

A negative determination at decision block 512 causes progression to decision block 516 wherein a determination is made whether to switch a keyboard and mouse. A positive determination at decision block 516 causes progression to process block 518 wherein connection information is sent to host unit controllers and device unit controllers. Flow then continues to process block 524 wherein the received connection information is stored by the controllers, after which flow loops back to process block 504.

A negative determination at decision block 516 causes progression to decision block 520 wherein a determination is made whether to switch a peripheral. A negative determination at decision block 520 causes flow to loop back to process block 510 wherein an error message is displayed at a user interface. Progression then loops back to process block 504.

A positive determination at decision block 520 causes progression to process block 522 wherein connection information is sent to peripheral user controllers and peripheral controllers. Flow then continues to process block 524 wherein the received connection information is stored by the controllers, after which flow loops back to process block 504.

While the present invention has been described in association with several exemplary embodiments, the described embodiments are to be considered in all respects as illustrative and not restrictive. Such other features, aspects, variations, modifications, and substitution of equivalents may be made without departing from the spirit and scope of this invention which is intended to be limited solely by the scope of the following claims. For example, it will be understood that the switching mechanisms of the present invention may also be located in the host unit instead of the device unit. In addition, the order of events in the flow charts is not to be construed as restrictive. Those skilled in the art will understand that the order may be changed without departing from the scope of the invention. Also, it will be appreciated that features and parts illustrated in one embodiment may be used, or may be applicable, in the same or in a similar way in other embodiments.

What is claimed is:

1. A distributed KVM and peripheral switch comprising:
a host unit communicably coupleable to a non-USB channel and a plurality of USB hosts;
a device unit communicably coupleable to the non-USB channel and at least one keyboard and mouse, at least one USB peripheral and at least one video display;
a master controller configured to switch the at least one keyboard and mouse among the USB hosts and configured to switch the at least one of USB peripheral among the USB hosts.

2. The distributed KVM and peripheral switch of claim 1 wherein the keyboard and mouse are selected from the group consisting of: USB keyboard and mouse, Sun keyboard and mouse, Mactintosh keyboard and mouse and PS/2 keyboard and mouse.

3. The distributed KVM and peripheral switch of claim 1 wherein a USB host is emulated to each of the keyboard and mouse devices and wherein a USB keyboard and mouse are emulated to each of the USB hosts.

4. The distributed KVM and peripheral switch of claim 1 further comprising a host controller in the host unit for controlling data flow and a device controller in the device unit for controlling data flow.

5. The distributed KVM and peripheral switch of claim 4 further comprising:
at least one user controller communicably coupled to at least one of the keyboard and mouse, the user controller being configured to emulate a USB host; and
at least one computer controller communicably coupled at least one of the USB hosts, the computer controller being configured to emulate a USB keyboard and mouse.

6. The distributed KVM and peripheral switch of claim 5 wherein the host controller and the at least one computer controller are the same controller.

7. The distributed KVM and peripheral switch of claim 5 wherein the device controller and the at least one user controller are the same controller.

8. The distributed KVM and peripheral switch of claim 5 wherein the at least one user controller and the at least one computer controller are communicably coupled via at least the non-USB channel.

9. The distributed KVM and peripheral switch of claim 5 wherein the master controller is configured to select which of the at least one user controllers and which of the at least one computer controllers will communicate with each other.

10. The distributed KVM and peripheral switch of claim 1 wherein the master controller is configured to control switching based on received user identification information.

11. The distributed KVM and peripheral switch of claim 10 wherein the user identification is received via a user interface selected from the group consisting of: buttons, RS232 commands, Ethernet, remote toggle switch, on-screen display, and combinations thereof.

12. The distributed KVM and peripheral switch of claim 1 further comprising a video switch communicably coupled to at least one video source and at least one of the video display and configured to switch the at least one video display among the at least one video source.

13. The distributed KVM and peripheral switch of claim 12 wherein the video switch is communicably coupled to the master controller.

14. The distributed KVM and peripheral switch of claim 1 further comprising a peripheral switch communicably coupled to at least one of the USB peripherals and at least one of the USB hosts and configured to switch the USB peripherals among the USB hosts.

15. The distributed KVM and peripheral switch of claim 14 wherein the peripheral switch is communicably coupled to the master controller.

16. The distributed KVM and peripheral switch of claim 1 wherein the distributed KVM and peripheral switch is compatible with both USB 1.x and USB 2.x.

17. The distributed KVM and peripheral switch of claim 1 wherein the host unit and device unit each comprise a non-USB transceiver for transmitting and receiving USB data over the non-USB communications channel.

18. The distributed KVM and peripheral switch of claim 1 wherein the host unit and device unit each comprise a non-USB to USB signal converter for converting non-USB signals to USB signals and a USB to non-USB signal converter for converting USB signals to non-USB signals.

19. The distributed KVM and peripheral switch of claim 18 wherein the USB to non-USB converter and the non-USB to USB converter of the host unit are the same converter and the USB to non-USB converter and the non-USB to USB converter of the device unit are the same converter.

20. The distributed KVM and peripheral switch of claim 1 wherein video device data is combined with USB data and transmitted from the device unit to the host unit.

21. The distributed KVM and peripheral switch of claim 1 wherein the non-USB channel comprises an at least four-pair communications channel.

22. The distributed KVM and peripheral switch of claim 21 wherein video data is transmitted on three pairs of the non-USB communications channel and USB data is transmitted on one pair of the non-USB communications channel.

23. The distributed KVM and peripheral switch of claim 22 wherein video device data is time multiplexed with USB data and transmitted on one pair of the non-USB communications channel.

24. A distributed KVM and peripheral switch comprising:
a host unit communicably coupleable to a non-USB channel and at least one USB host and at least one video source;
a device unit communicably coupleable to the non-USB channel and plurality of user input devices, at least one USB peripheral and a plurality of video displays;
a master controller configured to switch the USB input devices among the USB hosts and configured to switch the at least one USB peripheral among the USB hosts.

25. The distributed KVM and peripheral switch of claim 24 wherein the user input devices are selected from the group consisting of: USB keyboard and mouse, Sun keyboard and mouse, Mactintosh keyboard and mouse and PS/2 keyboard and mouse.

26. The distributed KVM and peripheral switch of claim 24 wherein a USB host is emulated to each of the USB input devices and wherein a USB keyboard and mouse are emulated to each of the USB hosts.

27. The distributed KVM and peripheral switch of claim 26 further comprising:
at least one user controller communicably coupled to at least one of the USB input devices, the user controller being configured to emulate a USB host; and
at least one computer controller communicably coupled at least one of the sets of USB hosts, the computer controller being configured to emulate a USB keyboard and mouse.

28. The distributed KVM and peripheral switch of claim 27 wherein the at least one user controller and the at least one computer controller are communicably coupled via at least the non-USB channel.

29. The distributed KVM and peripheral switch of claim 27 wherein the master controller is configured to select which of the at least one user controllers and which of the at least one computer controllers will communicate with each other.

30. The distributed KVM and peripheral switch of claim 24 further comprising a video switch communicably coupled to at least one video source and at least one video display and configured to switch the video displays among the video sources.

31. The distributed KVM and peripheral switch of claim 30 wherein the video switch is communicably coupled to the master controller.

32. The distributed KVM and peripheral switch of claim 24 further comprising a peripheral switch communicably coupled to at least one of the USB peripherals and at least one of the USB hosts and configured to switch the USB peripherals among the USB hosts.

33. The distributed KVM and peripheral switch of claim 32 wherein the peripheral switch is communicably coupled to the master controller.

34. A method for switching keyboard and mouse data, USB peripheral data and video signals over an extended distance, the method comprising:
receiving at a device unit USB keyboard and mouse data from a keyboard and mouse and USB peripheral data from a USB peripheral;
converting the received USB keyboard and mouse data to non-USB keyboard and mouse data suitable for transmission over a non-USB communications channel;
converting the received USB peripheral data to non-USB peripheral data suitable for transmission over a non-USB communications channel;
receiving at a host unit video data from a video source;
determining a destination USB host for the keyboard and mouse data, a destination USB host for the peripheral data, and a destination video display for the video data;
transmitting the non-USB keyboard and mouse data and non-USB peripheral data to a host unit via a non-USB communications channel;
transmitting to a device unit the video data;
converting the non-USB keyboard and mouse data received at the host unit to USB keyboard and mouse data;
converting the non-USB peripheral data received at the host unit to USB peripheral data;
transmitting the USB keyboard and mouse data and USB peripheral data to a USB host via a USB communications channel; and
transmitting the video data to a video display via a video communications channel.

35. The method of claim 34 further comprising emulating a USB keyboard and mouse to the USB host and emulating a USB host to the USB keyboard and mouse.

36. The method of claim 34 further comprising receiving a switching command at a master controller, the switching command containing identification information.

37. The method of claim 36 further comprising using the identification information to determine access rights.

38. The method of claim 36 further comprising determining whether the switching command is for a USB keyboard and mouse or a USB peripheral.

39. The method of claim 38 further comprising determining whether a USB keyboard and mouse are to be switched either independently or concurrently with a USB peripheral.
